(19) United States
(12) Patent Application Publication
(10) Pub. No.: US 2013/0087557 A1
(43) Pub. Date: Apr. 11, 2013

(54) Product And Package System To Produce Surface Color Change Through Retention Of Steam

(71) Applicants: Uraiwan Tangprasertchai, Inverness, IL (US); Anna Elizabeth Olsen, Chicago, IL (US); Kathryn Marie Birchmeier, Glenview, IL (US)

(72) Inventors: Uraiwan Tangprasertchai, Inverness, IL (US); Anna Elizabeth Olsen, Chicago, IL (US); Kathryn Marie Birchmeier, Glenview, IL (US)

(21) Appl. No.: 13/646,165

(22) Filed: Oct. 5, 2012

Related U.S. Application Data
(60) Provisional application No. 61/543,628, filed on Oct. 5, 2011.

(51) Int. Cl. H05B 6/80

(52) U.S. Cl. 219/730

(57) ABSTRACT

A product and package system for producing surface color changes through the retention of steam is provided. The package includes a food base that is rehydrated in the package system in a microwave during a first heating step. A topping component including a browning material is added and then heated during a second heating step to produce browning characteristics to the surface of the food.

### CROSS-REFERENCE To RELATED APPLICATION

This application claims benefit of U.S. Provisional Application No. 61/543,628, filed October 5, 2011, which is hereby incorporated herein by reference in its entirety.

### FIELD

The present application generally relates to a product and package system for producing a product surface color change. More particularly and in one approach, the present application relates to a microwaveable product and package system utilizing a multiple step process which causes a color change to the surface of the product through the retention of steam.

### BACKGROUND

Convenience foods typically require a minimum amount of consumer preparation and, thus, are in high demand to accommodate today's busy lifestyles. Microwave ovens are often used to heat, thaw, or cook the convenience foods. Microwave ovens tend to be limited to thawing frozen foods and/or heating pre-cooked, shelf stable, acidified, frozen, or chilled food dishes. Upon microwaving a shelf-stable product, the product results in a homogeneous product in taste and texture and resembles more of a steamed or stovetop prepared product than an oven-baked product.

Microwave cooked foods tend to lack the taste and appearance that result from oven baked processes. An oven-baked product is associated with having oven baked cues, such as color changes or browning of the product at its edges and/or upper surface and with having a dual texture such that the product may be crispier or dried on the outside while creamy on the inside.

Certain products, such as breaded foods, frozen pizza, chicken and the like may include a coating placed by the manufacturer on an exterior of the surface. The pre-applied coating is used to add a browned or cooked surface to the food. These types of food generally do not require any mixing or preparation by the consumer heating the food such that the coating pre-applied by the manufacturer remains on the exterior surface throughout the heating to provide a browned crust or surface. Such pre-applied coatings have limitations in other types of foods where mixing occurs either by the consumer or via self-mixing through boiling or movement of the food during cooking.

Other food products including a plurality of discrete pieces, such as pastas, potato dishes and the like oftentimes require intermediate mixing or stirring steps by the consumer heating the dish. In this regard, if a manufacturer were to pre-apply a coating on the exterior of the food pieces, the coating would become mixed into the dish prior to serving as a result of stirring. Additionally, certain dishes, particularly pasta, may boil or otherwise self-mix during microwave cooking as a result of the heating process such that any exterior, pre-applied coating may become intermixed within the dish. If a pre-applied coating is intermixed in the food dish, it will not provide the upper surface effect for color and/or texture, such as would result from oven baking, which leaves an upper layer or crust on a top surface of an entire mass of cooked food.

Current packaging for certain food products, such as shelf-stable, dehydrated products, can offer the option to add water directly to the packaging in which the dehydrated food is sold in and to microwave it in the very same packaging. One example is for dehydrated products, like pasta, where an optimal taste, texture and appearance can be more easily achieved when the pasta is hydrated by the consumer during product preparation. However, the amount of water added by the consumer can greatly influence the amount of residual water that remains in the product after cooking. If too much water is added, the excess will need to be drained whereas if too little water is added, the food may not be sufficiently hydrated.

### SUMMARY

In one aspect, a method for preparing a microwavable food providing to the microwavable food an oven baked appearance. The method includes first adding a dehydrated food base and water to a container. The container has a side wall and a central location spaced from the side wall where a radial distance from the container side wall to the central location is not equidistant about a periphery of the container. The container has a cooking chamber containing the dehydrated food base and water and a steaming chamber in a headspace of the container such that about 40 to about 45 percent of the container volume is the cooking chamber and about 55 to about 60 percent of the container volume is the steaming chamber.

Next, the method involved heating the dehydrated food base and water in the cooking chamber of the container in a microwave for a first heating period to form at least a hydrated food base with an amount of residual water separate from the hydrated food base remaining in the cooking chamber after the first heating period. A sauce component is then mixed with the hydrated food base and the residual water in the container. A topping component is added to a top surface of the rehydrated food base to form a topped food material. In one approach, the topping component including a browning material that is heat activated to effect a color change in the topping component. The topped food material is then optionally covered with a lid having a venting system.

Lastly, the topped food material is heated in the microwave for a further heating period so that the residual water amount, the optional lid, and the optional venting system on the lid are effective to generate a sufficient amount of steam to be retained in the steaming chamber to achieve a temperature in the headspace of about 200 to about 210° F. for heat activating the browning material to effect the color change in the topping component.

In another aspect, a microwavable food product system and container is provided. The container has a side wall and defines a central location where a radial distance from the container side wall to the central location is not equidistant about a periphery of the container. The container also defines a cooking chamber containing the dehydrated food base and a steaming chamber in a headspace above the cooking chamber such that a ratio of the cooking chamber to the steaming chamber is about 1 to about 1.4. A dehydrated food product base configured to be rehydrated with water by a user during a first heating period in a microwave is contained in the cooking chamber. The system may also include a sauce component and a topping component including a browning material. The topping component may be configured to be applied to a top surface of the food product base after being rehydrated. The browning material of the topping component is heat activatable to provide browning characteristics to the top surface of the food product base. In some approaches, the system further includes a lid configured to cooperate with the container. At least one of the container and lid defines or includes a venting system having through openings therein of about 0.5 to about 20 percent of the surface area of the container or lid. The lid and venting system are configured to permit an effective amount of steam to be retained in the steaming chamber to achieve a temperature of about 200° F. to about 200° F. in the headspace above the cooking chamber during microwave heating.

In other approaches, the method and/or system set forth above may also be combined with any of the additional features or methods steps, in any combination thereof set forth in this paragraph. For example, the further heating period may be at least about 30 seconds to about 1 minute, the venting system may include through openings on the lid wherein the through openings provide a venting area of about 0.5 to about 20 percent of the total surface area of the lid, the residual water may be about 8.5 to about 17 grams, the topping component may be about 70 to about 95 percent starch and about 5 to about 30 percent browning agent capable of undergoing a maillard reaction upon exposure to the steam and temperatures achieved in the steaming chamber, an anti-foam composition may be added to the dehydrated food base and water for the first heating step, the anti-foam composition including about 10 to about 30 percent surfactant, about 50 to about 70 percent instant starch, and at least about 15 percent salt component selected from sodium chloride or a sodium replacer, the dehydrated food base may be selected from the group consisting of pasta, rice, potato slices, bread crumbs, and mixtures thereof, a ratio of the first heating period to the further heating period effective to hydrate and result in the color change of the topping component may be about 5:1 to about 6.75:1, the steam may be generated from the residual water and water provided by the sauce component, the hydrated food base, sauce component, residual water, and topping component are not mixed or stirred prior to the further heating step, a ratio of the cooking chamber to the steaming chamber may be about 1 to about 1.4, the container side wall defines at least one corner, and/or the residual water amount, the lid, and the venting system may be effective to generate about 0.03 to about 0.5 grams of steam per second as well as any combinations of the above described variations of the method.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one form of a container;

FIG. 2A is a top view of one form of a lid;

FIG. 2B is a top view of another form of a lid;

FIG. 2C is a top view of yet another form of a lid;

FIG. 3 is a side view of a container and lid combination showing steam venting;

FIG. 4 is a top view of a container prior to the addition of a food component;

FIG. 5 is a top view of the container of FIG. 4 after pasta has been added;

FIG. 6 is a top view of the container of FIG. 5 after a topping component has been added;

FIG. 7 is a cross sectional view of the container and lid combination of FIG. 3;

FIG. 8 is a process flow diagram for one method of preparing a food product with oven baked qualities;

FIG. 9 is a picture of one form of pasta with a topping component after browning;

FIGS. 10-13 are pictures of various sample pasta, container and lid combinations;

FIGS. 14-16 are graphs of temperature profiles of microwave cooking;

FIG. 17 is a picture of a temperature probe in a sidewall of a container;

FIG. 18 is a picture of a temperature probe in a lid of a container; and

FIG. 19 is a picture of a temperature probe used in a container without a lid.

### DETAILED DESCRIPTION

Generally, a food kit and a method are provided that utilize a microwavable container with a multi-step microwave preparation method for achieving the appearance and organoleptic characteristics of an oven-baked product. The food kit includes one or more base components that may be heated and/or hydrated in a first step in the microwavable container. In a further step, a browning topping component is applied and further heated in the container with a lid arranged and configured with a venting system effective to retain a select amount of steam within a steaming zone of the container to activate the topping component to provide oven baked attributes on an upper surface of the product. The methods, packaging, and compositions described herein, therefore, are effective to achieve an oven-baked appearance in a microwave oven.

Oven-baked attributes may include a change in color to the food and/or a change in texture to the food. Conventional oven cooking provides a product that has a color change, such as browning along the product edges and/or upper surfaces, as well as a texture change where the outside may be drier and crispier while the inside remains moist and/or creamy. As explained in the background, microwave cooking usually does not produce oven-baked results, in part due to shorter cook times, lower temperatures, and the inherent inability of a microwave oven to achieve crisping and browning.

It should be understood that where the “browning” of the product is mentioned, this refers to the darkening in color of the food product (relative to a pre-cooked state) and not that the actual color of the product is brown. The actual color of the “browned” food product may be any color and can vary from a brown or black color to a dark orange color and so on. Additionally, wherever hydration of the dehydrated product is mentioned this should be understood to imply that the product can be either partially hydrated or fully hydrated.

In one aspect, the methods herein provide an oven-baked-type appearance to a microwave cooked food. By one approach, this oven-baked appearance is achieved through a two-step cooking process where a first microwave heating step is configured to hydrate a food product with a select amount of water effective to not only achieve hydration of the food but also to leave a sufficient amount of residual or free water available to produce steam in a subsequent or second heating step. A browning topping material, such as a particulate starch and malloise based material, effective to create a browned or baked appearance upon contact with steam, is sprinkled or applied on the top of the hydrated food from the first step. Then, a lid configured to retain a select amount of steam is used to cover the container holding the product. The product is again cooked in a microwave for a second time. By one approach, cooking times of the first and second steps are in a ratio of about 5:1 to about 6.75:1 (i.e., about 4 to 4.5 minutes for a first cooking step, and about 40 to about 45 seconds for a second cooking step) to achieve effective hydration in the first heating step and effective steam generation in a second heating step.

In another aspect, an effective amount of steam is generated by residual and free water from the first heating step to activate the browning topping material to cause Malliard reactions to create a browned and oven-baked appearance. The water source for the steam is obtained from added water and moisture from any of the food ingredients. In this aspect, the steam generated from the cooking is collected in a steaming space or chamber formed above the product. The chamber is sized and shaped to provide sufficient contact of the steam with the topping material. A lid having a venting system configured to retain the proper amount of steam is used to maintain the steam in the chamber. By one approach, the effective amount of steam may be, in part, based on the volume of the steaming chamber, an amount of the applied topping material, an amount of residual or free water from the first heating step, and/or the cooking time of the second heating step.

In yet another aspect, the configuration of the venting system on the lid may aid in retaining the effective amount of steam in the steaming chamber. Vent size, shape, and location may impact proper steam retention to achieve the desired browning for an oven baked appearance. By one approach, the container used in the methods herein is square, which is inherently a poor microwave cooking container due to different radial lengths between the outer surface and the center of the food to be cooked. Thus, in some approaches, vent opening surface area and location on the lid may be selected for effective steam generation based on the container size and shape.

The microwave container and methods herein can be used with any food product that an oven-baked appearance is desirable. In one form, the food product may be a dehydrated food product that is hydrated by the addition of water and microwaving. For instance, the final food product can be a macaroni and cheese meal, an au gratin potato or other type of potato meal, a bread stuffing mix, a rice mix and the like. The microwave container can be used with any multi-part process for preparation of a food component where the first step requires heating or cooking a portion of the food and a later step comprises adding a topping component that is to remain on an upper surface of the final product and aids in browning the upper surface of the product upon heating in a microwave while contained in a package having a lid. In this regard, the container and lid aid in steam activating the topping component.

The method for heating/cooking the food generally comprises a multi-step process involving microwave heating the base food product. This step may also include the addition of water to hydrate the product in the container followed by a further heating step after addition of a further food component, such as a topping component, to brown the product and achieve oven-baked cues. The multi-step heating process also utilizes the vented lid in a further step so that proper water content is available to generate the desired amount of steam to brown the topping component and achieve the oven-baked cues.

The food product may take the form of a ready-to-eat type product requiring heating and/or cooking. Further, the food product may take the form of a shelf stable packaged composition that does not require refrigeration. For example, the base component may include a dry, dehydrated product that is later rehydrated before consumption. In one aspect, examples of dry, dehydrated products can include pasta, dried or dehydrated potato slices, dried bread crumbs, and any other food that can be rehydrated by addition of water and heating in a microwave. In another aspect, the dehydrated food can include a starch-based food product, such as potatoes, rice, and the like. It should be understood that wherever a pasta product is mentioned herein, such discussion regarding pasta can similarly refer to any dehydrated product for which this multi-step heating process is appropriate to achieve an oven-baked appearance. Generally, if the food product includes pasta and other dehydrated materials, the water content of those starting materials is low and/or negligible. Alternatively, the food product may include a hydrated material such as hydrated pasta or potatoes that have a known water content.

The food product may also include a sauce or other food component added to the food product such as a cheese sauce, a tomato-based sauce, and the like. In one form, the sauce component is a shelf stable material. The sauce component may be a dehydrated sauce that may be rehydrated within the container or externally to the container prior to combination with the pasta. Alternatively, the sauce component is a shelf stable liquid sauce that contains water, oil and other materials.

The food product may also include seasonings and anti-foaming components to add flavor and minimize foaming while heating in a microwave. The seasoning and/or anti-foaming components may be included as a part of one of the other components, such as the base pasta component or the sauce component. Alternatively, the seasoning and/or anti-foaming components may be added as a separate step. For example, the seasoning and anti-foaming components may be added with the water to the pasta to hydrate the pasta while minimizing foaming during the first or initial heating step. Such seasoning or other food components can comprise potato flakes, anti-foaming agents, flavorings, or other foods such as broccoli, bacon pieces, other vegetables, cheese, meat, and so forth.

By one approach, the anti-foam composition may include about 10 to about 30 percent surfactant, about 50 to about 70 percent instant starch, and at least about 15 percent salt, which may include sodium chloride and/or a sodium replacer, such as potassium. In another approach, the anti-foam composition includes about 10 to about 20 percent surfactant, about 50 to about 60 percent instant starch, and about 20 to about 30 percent salt. In yet other approaches, the anti-foam composition includes about 12 to about 17 percent surfactant, about 55 to about 60 percent instant starch, and about 23 to about 28 percent salt (including both sodium chloride and sodium replacer).

Suitable surfactants for use in the anti-foam composition may include monoglycerides, diglycerides, derivatives thereof (e.g., acetylated monoglycerides, succinylated monoglycerides, citrated monoglycerides, and the like) as well as mixtures thereof. Acetylated monoglycerides are generally suitable for the compositions herein.

Suitable instant starches for use in the anti-foam composition may include instant and/or pregelatinized starches such as corn or tapioca starches and the like as well as mixtures thereof. By one approach, suitable instant starches may include pregelatinzed corn starch, instant tapioca starch, and mixtures thereof. Although not wishing to be limited by theory, it is believed that the instant starch increases the viscosity of the aqueous medium at ambient temperatures and helps to maintain that viscosity increase at boiling temperatures.

Suitable salts for use in the anti-foam composition may include sodium chloride, potassium chloride, magnesium chloride, the sodium replacers discussed above, and the like as well as mixtures thereof. Sodium chloride is one suitable salt for the applications and compositions herein. Again not wishing to be limited by theory, it is possible that the salt provides a salting out effect, modifies the surface potential of the pasta, modifies the viscosity of the aqueous medium, and/or increases the boiling point of the aqueous medium.

Suitable sodium replacers may include those discussed above such as potassium chloride, modified potassium chloride, bonded potassium chloride and mixtures thereof. Not wishing to be limited by theory, the sodium replacers may also provide a salting out effect, modify the surface potential of the pasta, modify the viscosity of the aqueous medium, and/or increase the boiling point of the aqueous medium.

In the second or further heating steps, the food product may also include a topping component having a browning component. The topping and/or browning component may be steam activatable and therefore may depend on the amount of water content of the food components when added as well as the steam retention in the container. By one approach, the topping component may include potato flakes, cracker materials, other starch materials as well as Maillose. The composition of the topping component may be varied depending on the base food component and also on the desired amount of browning and texture. By one approach, the topping component may include about 70 to about 95 percent starch component and about 5 to about 30 percent browning agent, such as Maillose. In one form, the topping component includes about 82 percent starch, such as granulated breadcrumbs or granulated, dried potatoes, with about 12 percent browning agent, such as Maillose. Generally, these materials undergo a heat induced maillard reaction as a result of contact with an effective amount of steam which results in browning.

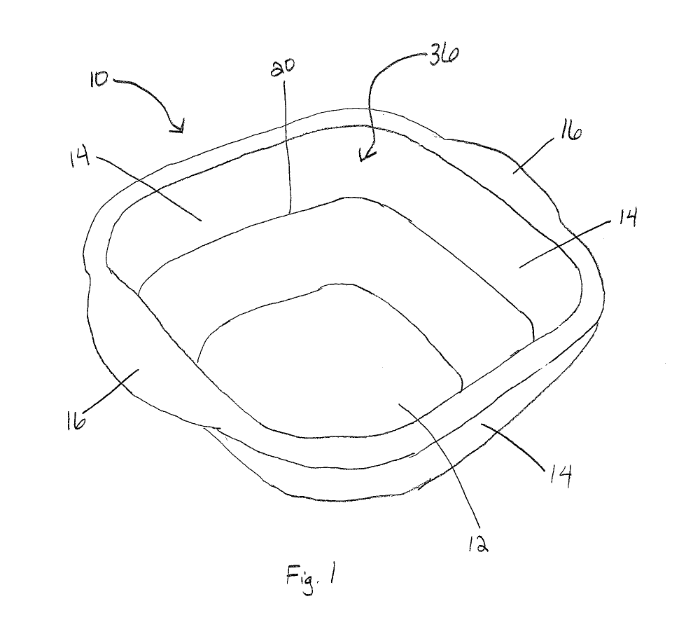

Turning to more of the specifics and referring to FIG. 1, a container 10 is provided having a base 12 and one or more upstanding sidewalls 14. In one form, the container 10 also includes handles 16 to help an individual carry the container 10. It should be noted that the handles 16 are optional and need not be included on the container 10. By inclusion of the optional handle 16, the container tends to resemble a casserole dish common for oven baking.

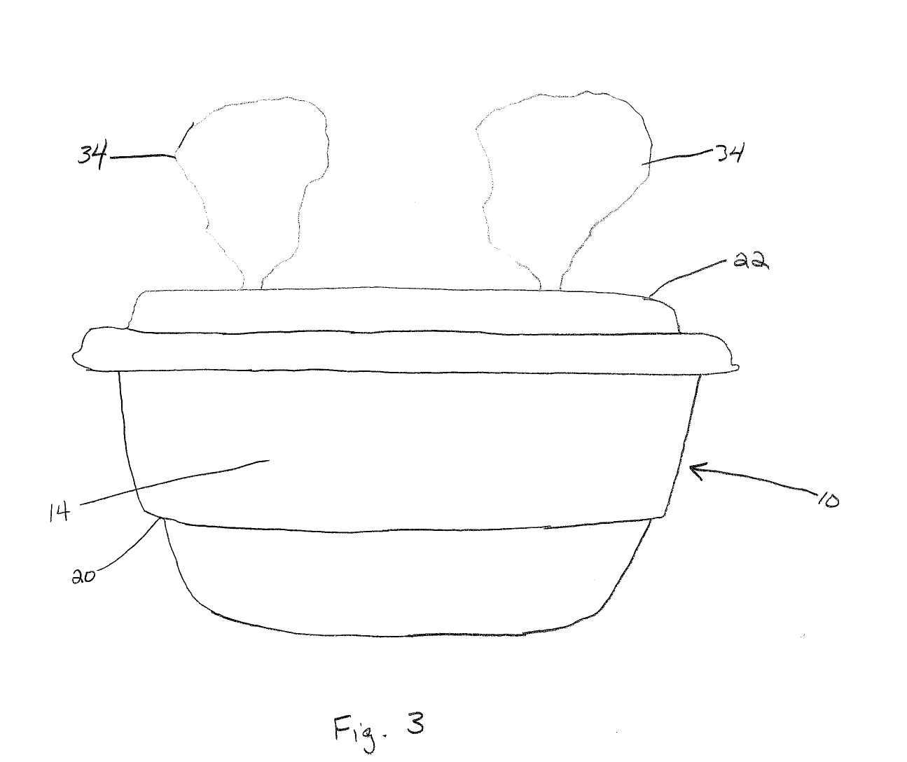

The container 10 may also include a fill line indicator 20, such as positioned on a sidewall 14. As seen in FIG. 1, the fill line indicator 20 extends along all four of the sidewalls 14. However, the fill line indicator 20 need not extend entirely around the container 10. The fill line indicator 20 may take a variety of forms and can be provided in many different manners, such as by embossing, engraving, printing, providing a geometric feature such as a step and the like. As best seen in FIG. 3, in one form, the fill line indicator 20 is in the form of a step that can be readily seen from above. The fill line indicator 20 may also be printed or otherwise visible on an interior and/or an exterior of the container 10. Alternatively, the container need not include any indicator at all.

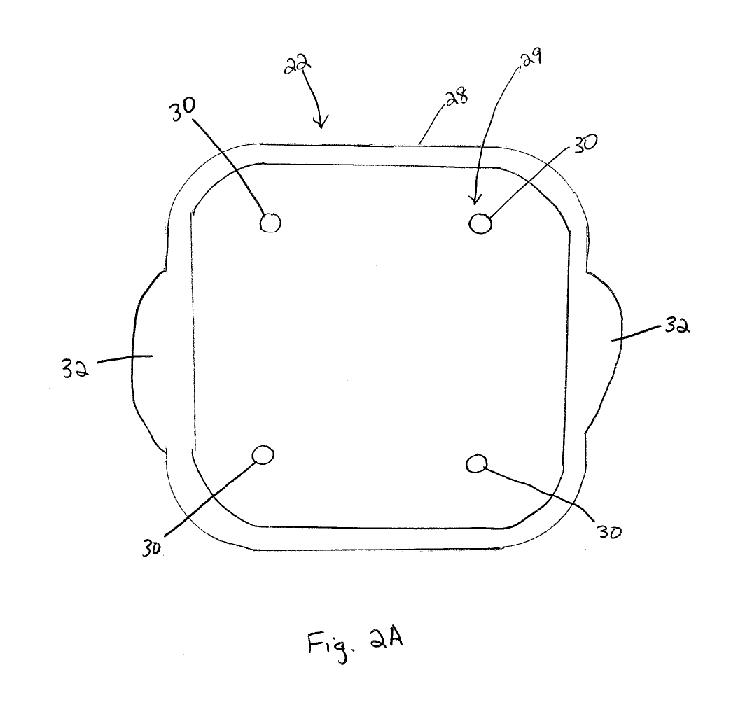

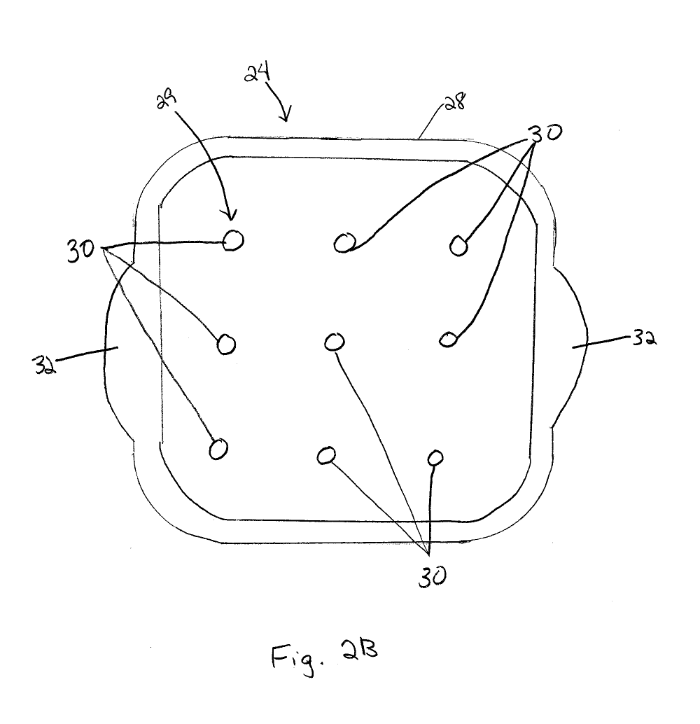

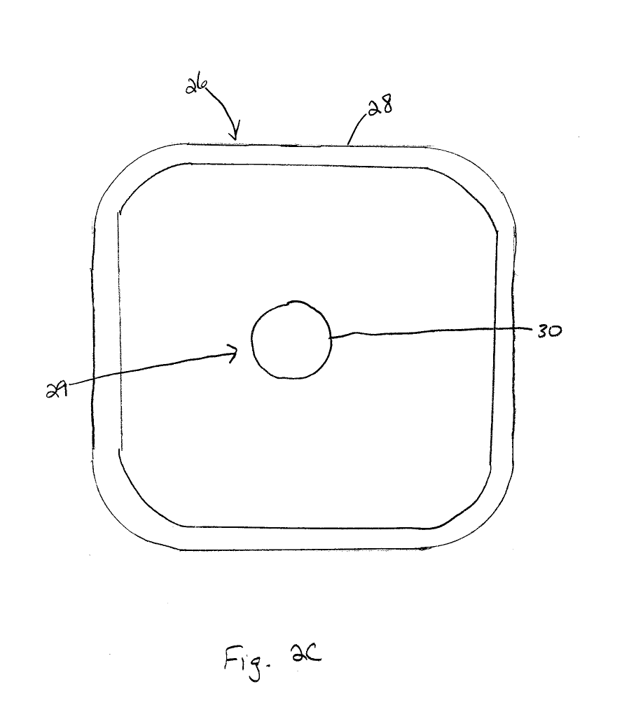

A lid may also be utilized to cooperate with the container 10. For example, various forms of lids 22, 24, 26 are illustrated in FIGS. 2A-2C. The lids 22, 24, 26 may include an edge 28 that cooperates with the sidewalls 14 of the container to generally seal against the sidewalls 14 of the container 10. It should be noted that the edge 28 may also include a flange located generally at the top of the sidewalls 14 to provide a larger sealing surface area. The lids 22, 24, 26 may also include a venting system 29 configured to operate in conjunction with a headspace volume in the container and an effective amount of steam over a prescribed microwave cooking time to activate the browning agent and achieve browning consistent with an oven baked product. It should be noted that the venting system 29 may take a variety of forms. For example, the venting system 29 may include apertures or gaps in the fit between the lid and the container. In another form, the venting system 29 includes pressure release valves contained in a flexible film and other methods of venting steam. The browning rate, extent and evenness may be controlled by the size, and location of the vent system 29. Similarly, the amount and type of topping component and browning agent may also be modified to cooperate with the type of venting system 29 to provide the desired appearance.

By one approach, the venting system 29 includes one or more vent openings 30 in the lid. In some forms, such as in FIGS. 2A and 2B, the lids 22 and 24 include handles 32 which cooperate with the handles 16 of the container. The lid 26 may be used with a container that may or may not include handles.

As seen by comparing FIGS. 2A-2C, the position and size of the openings 30 may be varied and may be tailored with respect to the container size, volume, and shape to achieve the desired browning. For example and in one form, such as in FIG. 2A, there are four openings 30 spread out over the lid 22. In this form, each of the openings 30 generally forms about 0.5 to about 10% of the total surface area of the lid 22. In another form, the openings form about 5 to about 20% of the total surface area of the lid. In another form, as in FIG. 2B, additional openings 30 are positioned on the lid 24. In this form, the sizes of the openings 30 may be varied to provide the same percent of the total surface area of the lid 24. Alternatively, the openings 30 may be made larger or smaller to provide more or less retention of the steam in the headspace of the container above the food while it is being cooked. In yet another form, as in FIG. 2C, a single opening 30 is positioned towards the center of the lid 26. In this form, the opening 30 was approximately 20 percent of the surface area of the lid 26 which permitted too much steam to escape and did not provide the desired browning.

The openings 30 may take a variety of sizes, shapes and locations on the respective lid. The size, shape and location may impact the amount and level of browning achieved. For example, depending on the shape of the container 10 and lid 22, 24, 26, the openings may be placed at different locations. For example, a square container and lid may have a different arrangement of openings. Similarly, the openings may be square, round, rectangular and the like to provide the desired amount of surface area and to permit a desired amount of steam 34 to escape from the container and lid combination, such as shown in FIG. 3. In one form, the openings may permit about 0.03 g/second to about 0.50 g/sec steam to be generated and at least a portion of this steam may be vented from the steaming chamber while the remainder is maintained in the container and lid combination during the second cooking step to provide heat and steam to the topping component and result in browning. The venting system helps increase the temperature via steam generation and flow, but also avoids excessive steam condensation which may adversely affect the browning reaction and texture change of the topping component. While an exemplary steam rate is provided above, this steam rate may not be constant throughout the second cooking step and may vary throughout the cooking durations. The above ranges may be averages of steam generation throughout the second cooking step.

As best seen in FIG. 1, the container 10 is generally larger than the fill line indicator 20 such that when the pasta is hydrated, there is still a head space 36 which would be positioned between the pasta and the top of the lid. The head space 36 permits steam to accumulate and to create a rise in temperature. The head space 36 may also permit any steam that is generated to circulate within the container and lid. As noted above, the topping component is generally heat and/or steam activated and therefore the head space 36 helps maintain an effective amount of the steam in contact with the topping component. In one form, a head space volume forming the steaming chamber encompassing less than half of the container volume is desired. In another form, a head space volume forming the steaming chamber encompassing more than half of the container volume is desired. By one approach, the container as about 40 to about 45 percent of its volume sized as a cooking chamber and about 55 to about 60 percent of its volume sized as a steaming chamber. In another form, the ratio of the cooking chamber to the total container volume is about 1 to 2.5 and a ratio of the cooking chamber to the steaming chamber is about 1 to about 1.4. In some approaches, a larger headspace is less desired because it takes longer to accumulate sufficient steam to impact browning.

The head space volume helps create a steaming space for causing the browning reactions. In essence the head space volume is a steam activation volume as it helps activate the browning agents in the topping component.

The container may be made from a variety of different materials such as polymeric materials, paperboard, laminates of paperboard or other materials. Upon formation of the final container, the container can result in a rigid or semi-rigid container. The terms “rigid” and “semi-rigid” are used herein to indicate that the structures made have the ability to generally retain their respective shapes during normal handling.

The shape of the container can be any appropriate shape for microwave cooking food components and, in particular, should be sized appropriately such that it fits inside of a standard sized microwave oven. In one aspect, the shape of the container can comprise a square, a circle, a rectangle, or any other appropriate shape. In another aspect, a non-cylindrical shape is preferred. By one approach, the container is rectangular shaped where a radial distance from the container wall to a center point is not equidistant all the way around the container.

As seen in the figures, the container may take the form of a generally square container. It should be noted that such a container is not necessary the optimal shape for cooking in a microwave as the microwaves do not evenly penetrate the container due to the corners. A circular shape, on the other hand, would generally permit equal penetration and heating. This unique heating consideration of a square or rectangular container adds further oven baked qualities to the container and product as the edges, and more particularly the corners, may have more of an oven baked appearance.

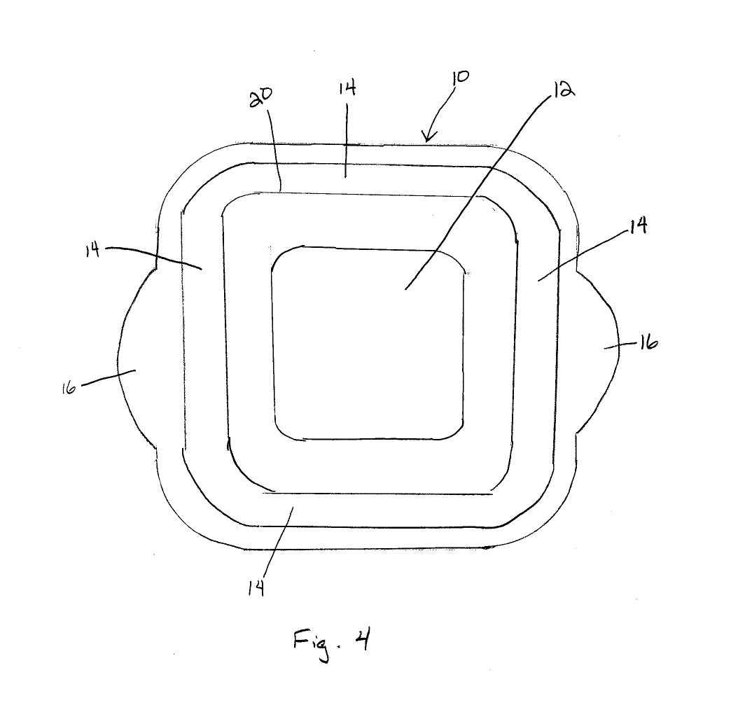

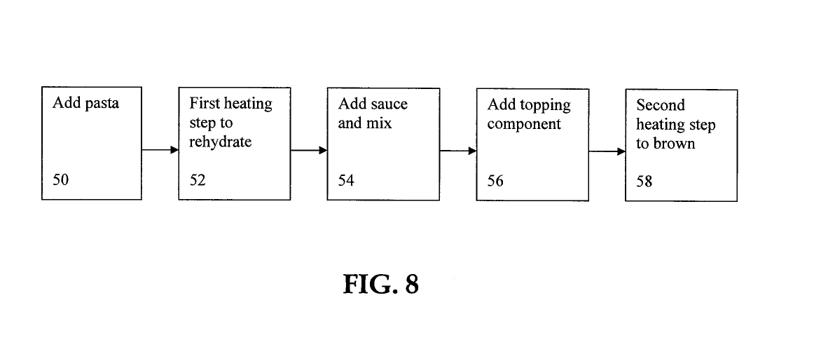

A method for preparing a microwave food having an oven baked appearance using a multi-step process will now be discussed with reference to FIG. 8 with exemplary forms of the container shown in FIGS. 4-6. It should be noted that while the container 10 in FIGS. 4-6 is illustrated without a lid to show the internal contents, the method includes placing the lid on the container 10 for at least the step of heating and activating the topping component. Further, the lid may also be used in other heating steps as desired or necessary to maintain the desired water content for the specific heating steps.

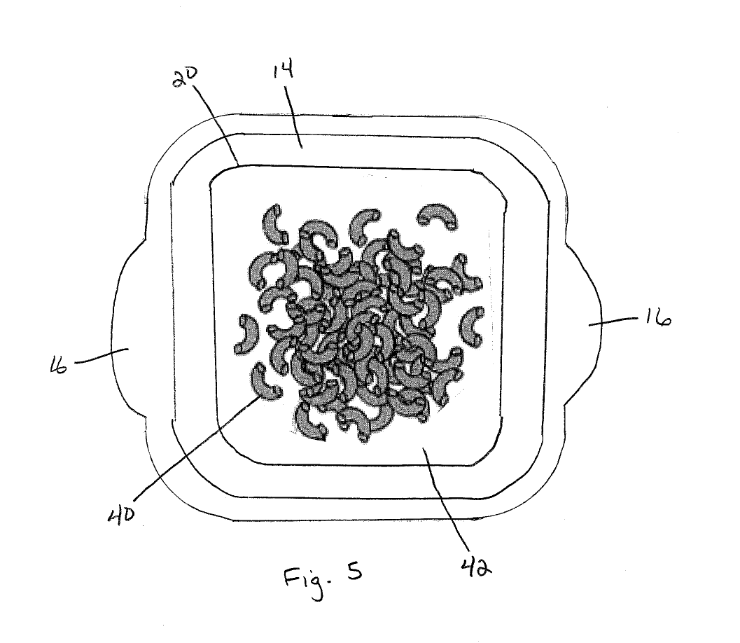

In one form, each of the components of the food product may be packaged within the container 10 in one or more packets or packages (not shown) and removed from the container prior to addition in the appropriate step. Referring now to FIG. 4, a top view of the container 10 is shown prior to the addition of any food components. In one exemplary form, the food product included in the container 10 can be a dehydrated, shelf-stable base food, such as dry pasta noodles 40 shown in FIG. 5. The pasta noodles can be added to the container, such as at step 50 in FIG. 8 and then at least partially rehydrated by adding water 42 and heating for a first heating step in a microwave (not shown) for a first period of time, such as at step 52. In one form, a seasoning component and/or an anti-foam component may be added to the container 10 with water prior to heating for the first period of time. Additionally, the lid may or may not be used during heating for the first period of time. By one approach, the lid is not used in the first heating step.

After rehydration of the shelf-stable product in the first heating step, a sauce (not shown) may then be added and mixed into the product, such as at step 54. The sauce may be a dehydrated sauce that utilizes residual water in the container 10 or may be a liquid-based sauce containing water and/or oil as previously described. The sauce is generally incorporated by mixing into the pasta with a spoon of other utensil.

After the sauce has been mixed with the rehydrated pasta, the topping component may be added to the top of the rehydrated pasta without mixing into the pasta, such as at step 56. It should be noted that the topping component remains on the upper surface of the pasta. Further, in one form, the topping component only partially coats portions of the pasta at the top and other portions of the pasta are not coated with the topping at all. In other words, the topping component would not coat or contact pasta located as the bottom of the container as the topping component is not mixed such that it is only contacts portions of the upper surface of the uppermost pieces of pasta.

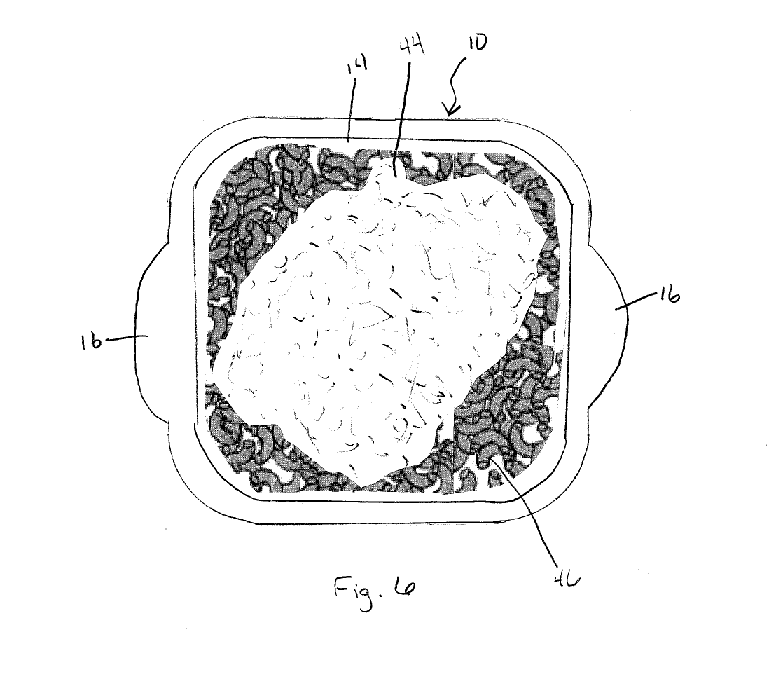

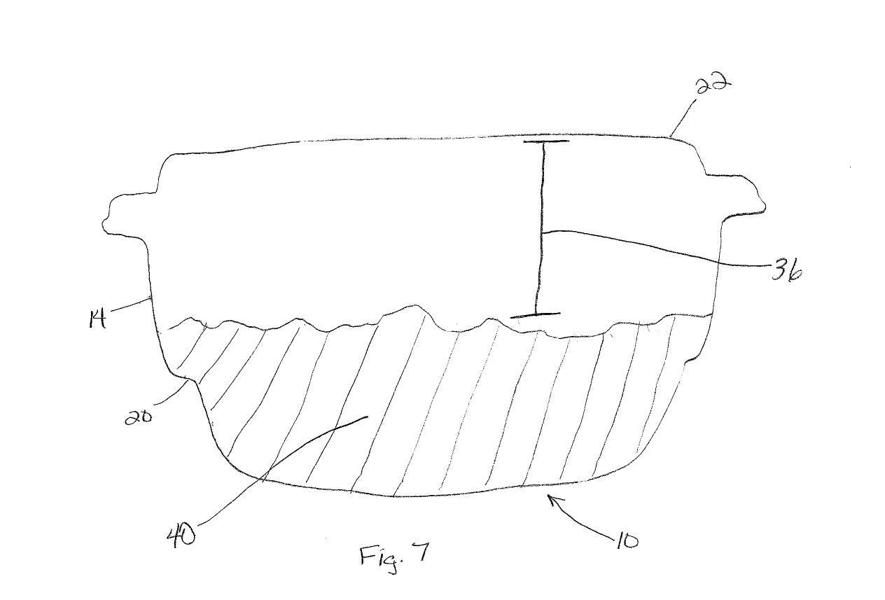

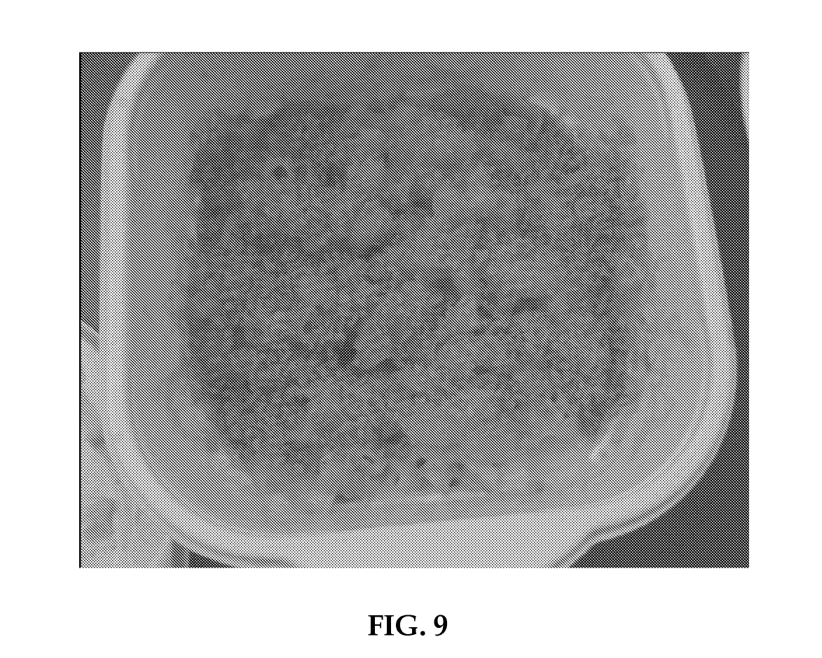

The combined rehydrated pasta and topping component is then heated in a second or further heating step in the microwave, such as at step 58. During this second heating step, the lid is placed on the container such that the lid and venting system ensure an effective amount of steam contacts the topping component for a specified amount of time to activate the topping component. It is during the further heating step that the browning of the food product, and in particular, the topping component, occurs due to the fact that the topping component is not present during the first heating step. It should be noted that the topping component must be added at the end of the cook process to prevent it from dispersing, sinking and being mixed with the sauce or water during the boiling process. Adding the topping component prior to rehydrating the pasta would not result in an oven baked appearance because the topping would be blended within the pasta rather than on an upper surface of a mass of pasta. The resulting browned topping component 44 and rehydrated pasta 46 is illustrated in FIG. 6. Additionally, exemplary topping coated pastas are shown in FIG. 9.

As noted previously, the lid can provide several functions, one of which is to retain heat and/or steam in the container 10 upon heating. Further, the lid contains one or more vent holes to allow some but not all of the steam to escape from the interior of the container 10 into the interior of the microwave as too much moisture present in the food can inhibit the browning process of the food product within the container 10.

The amount of water in the system is selected to appropriately rehydrate the pasta and also ensure sufficient water for creation of the desired steam levels for browning. Water may be provided, in some approaches, from added water and in a liquid sauce. The water amount that is needed can be determined by the fill level indicator 20 in the sidewall 14 of the package 10 (i.e., adding water up to this line) or can be premeasured by the consumer. The amount of water is just enough to rehydrate the dry food product without retaining too much residual water after heating. Thus, the amount of water indicated in the container 10 should be selected such that just enough residual water remains after heating to mix with the cheese sauce component if necessary. Further, there should be sufficient water content, as residual water or the water content from the pasta and/or sauce, to permit steam to form and activate the browning material, but not too much to inhibit production of the browning and dual texture attributes. The amount of water needed to hydrate the pasta depends primarily upon the amount of dry product that is placed in the container and the length of time it is heated for in the microwave. In one aspect, where about 60 to about 74 grams of dry pasta noodles are provided in the container, about 156 to about 187 grams of water can be added to rehydrate the noodles upon heating at a maximum power setting in the microwave for about 3 to about 5 minutes. Such proportions are effective to hydrate and retain sufficient water for steam generation in a second heating step.

The amount of residual water remaining in the container 10 after heating can also be a factor of both the amount of water initially added to the container 10 as well as the amount of time the water and pasta are heated together inside the microwave. In one aspect, the water and pasta can be heated in the microwave for about 3 to about 5 minutes at an energy level between about 800 watts to about 1300 watts. However, the pasta can be heated more or less depending upon the amount of water initially added to the container, the amount of pasta in the container, the amount of residual water desired to be present after heating is completed, as well as other relevant factors. In general, it is desirable to microwave the pasta and water until the pasta is at least partially hydrated and the majority of the free water is absorbed. In one form, such as for the ranges of ingredients provided above, the amount of residual water in the container may be about 8.5 to about 17 grams, but it may be more or less depending on the application and food type among other factors.

The amount of time required to heat the pasta topping component during the second or further heating step depends on many factors, some of which include the amount of product in the container, the volume of the head space, the container geometry, the ingredients of the sauce or the topping component added and how they respond to browning, how crispy or brown of a final product is desired, and so forth. Thus, in one aspect, the further heating step can be provided for about 45 seconds, however, more or less time can be provided. In general, a heating step anywhere from 30 seconds to 1 minute can be provided as the further heating step, but more or less time can also be provided dependent upon the many factors already identified and what final result is desired in the product. The longer the sauce and pasta are cooked during the further heating step the more there is a possibility for some of the flavor in the sauce to be lost or altered. Thus, an ideal heating time would be such that the amount of browning and/or texture change is balanced with the flavor result that is also desired.

The oven-baked attributes that are desirable include both having an appearance of the final product that looks “oven-baked,” such that it looks like it was baked in the oven resulting in browning, as well as having an oven-baked texture of the product, such as having a dual texture. The oven-baked appearance comprises the color change that can result upon heating in the microwave such that browning of the food product along the product edges and surfaces is observed. The dual texture that is desired can comprise a crispier or drier outer surface having a creamy inner surface.

Additional oven baked attributes include browning of sauce and/or topping component on the side walls of the container and on the upper portion of the container above the fill line indicator. In this regard, the container will give the appearance of a casserole type dish that had been baked in an oven where the sauce on the sides of the casserole dish has been browned.

The product components that are initially packaged can include a dry, dehydrated shelf stable food product, such as a dry pasta, and segregated food components packaged in one or more pouches that are to be added and mixed into the dehydrated product before and/or after initial heating of the dry product. The product components are packaged in the container so that they can be later cooked/heated in the container.

It is believed that these results are obtained by both direct conduction of heat in the microwave as well as exposure to steam heat created by the microwave. In order to brown the product, it is believed that a maillard reaction may be occurring which, through activation by heat, a chemical reaction occurs that results in nonenzymatic browning. In particular, it can be the combination of application of heat to the product and a component in the food product itself, such as the topping component that is receptive to browning and reacts to cause the product to brown.

Advantages and embodiments of the compositions described herein are further illustrated by the following examples; however, the particular conditions, processing schemes, materials, and amounts thereof recited in these examples, as well as other conditions and details, should not be construed to unduly limit this method. All percentages are by weight unless otherwise indicated.

### EXAMPLES

### Example 1

A first set of samples was prepared to compare various lid and venting systems for creating the desired browning characteristics. Samples A-D were prepared by combining about 70 g dehydrated elbow pasta with 225 g water and 4 g antifoam in a round polypropylene container. The container was heated for approximately 8 minutes until the pasta was sufficiently hydrated. Next, 50 g of a cheese sauce mix was mixed with the hydrated pasta. Finally, a topping component including about 3g potato flakes and 0.25 g Maillose was added to the top of each of Samples A-D. Each of the samples was covered as outlined below and heated for a further 30 seconds.

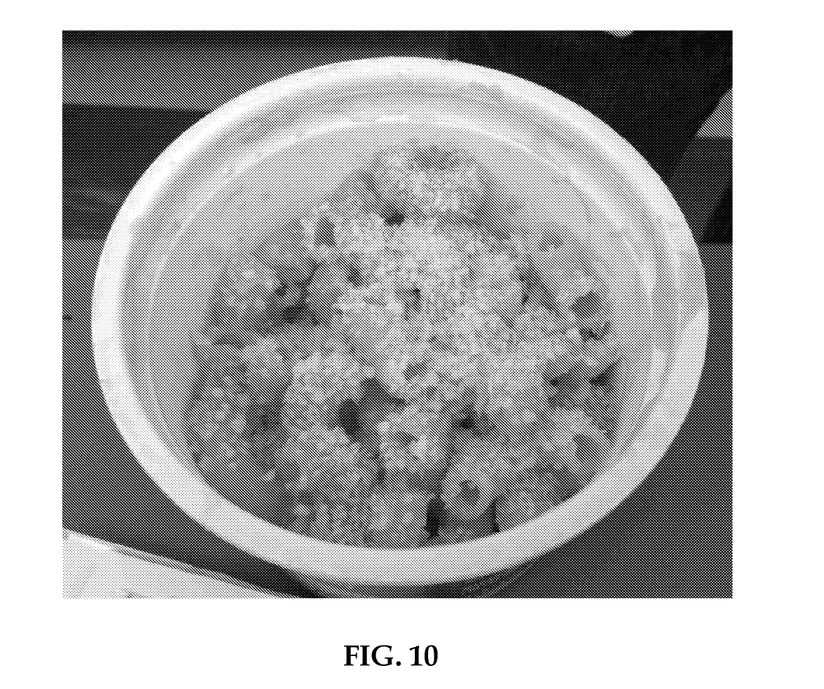

Sample A was not covered at all during the heating steps, including the heating step after the topping component was added. A picture of the resulting pasta and topping is shown in FIG. 10. As seen in this figure, very little browning occurred to the topping component.

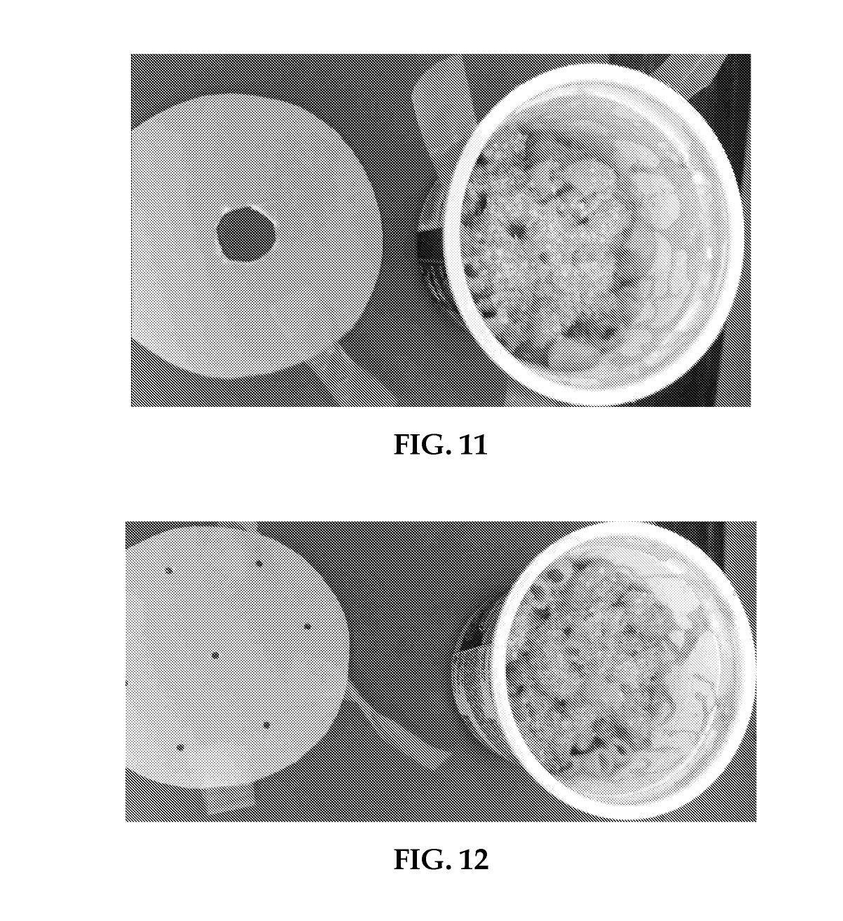

Sample B was covered only during the second heating step after the topping component was added. The lid used for Sample B is shown in FIG. 11. As seen in this figure, the lid has a single large opening centrally located on the lid such that some steam was trapped, but a significant amount of steam was permitted to escape from the container into the general atmosphere of the microwave. As also seen in FIG. 11, the edges of the food did start browning, but overall, the food did not have sufficient browning. However, it should be noted that generally, the food had improved browning characteristics than Sample A.

Sample C was covered only during the second heating step after the topping component was added. The lid used for Sample C is shown in FIG. 12. As seen in this figure, the lid has seven smaller openings spaced evenly around the lid such that more steam was trapped than with Sample B, but some steam was permitted to escape from the container into the general atmosphere of the microwave. As also seen in FIG. 12, the topping component has even further browning than Sample B and that the browning was more evenly distributed across the surface of the food.

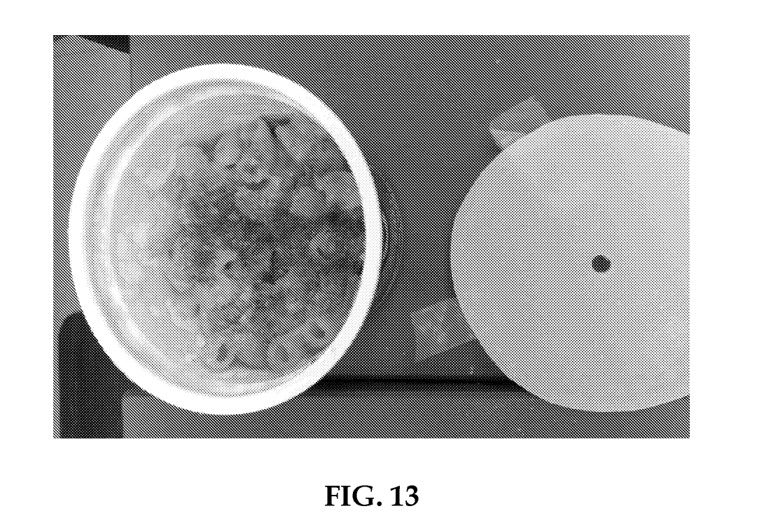

Sample D was covered only during the second heating step after the topping component was added. The lid used for Sample D is shown in FIG. 13. As seen in this figure, the lid has a single smaller opening centrally located on the lid such that a large portion steam was trapped, with a small amount of steam permitted to escape from the container into the general atmosphere of the microwave. It should be observed that the size of the opening in FIG. 13 is smaller than the size of the opening in FIG. 11. As also seen in FIG. 13, the surface of the food has a darker color than Sample C in FIG. 12 such that the color almost begins to appear artificial. This lid may be optimized with a shorter cook time to avoid excessive browning.

### Example 2

A number of examples were prepared to analyze browning efficacy over various heating time periods. Dehydrated pasta was rehydrated in a generally square container (similar to FIG. 1) for approximately 4 minutes and 30 seconds in each of the examples using the amounts of water listed in Table 1. No lid was used during the first cooking step. After rehydration, the mass of each example was measured to determine the amount of water retained after the rehydration step. Next, a cheese sauce component was added and mixed with the rehydrated pasta. Next, a topping component was added in the amounts listed in Table 1. Finally, each of the examples was heated for a second time for the amount of time listed in the Table 2.

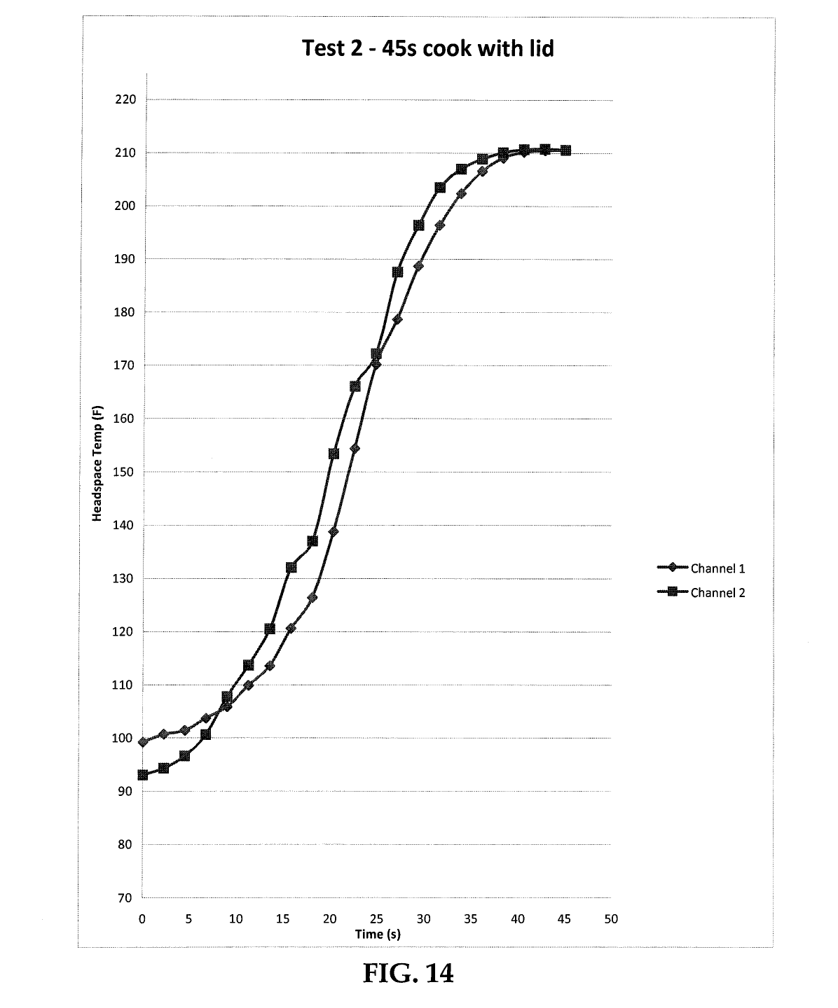

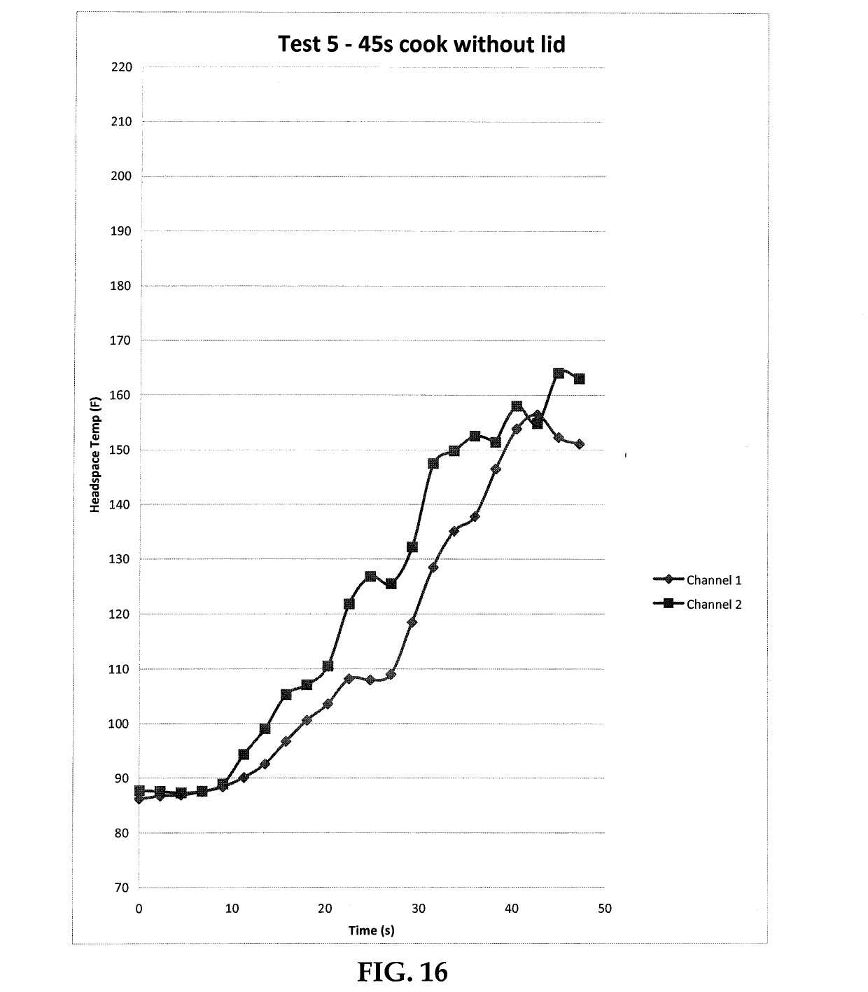

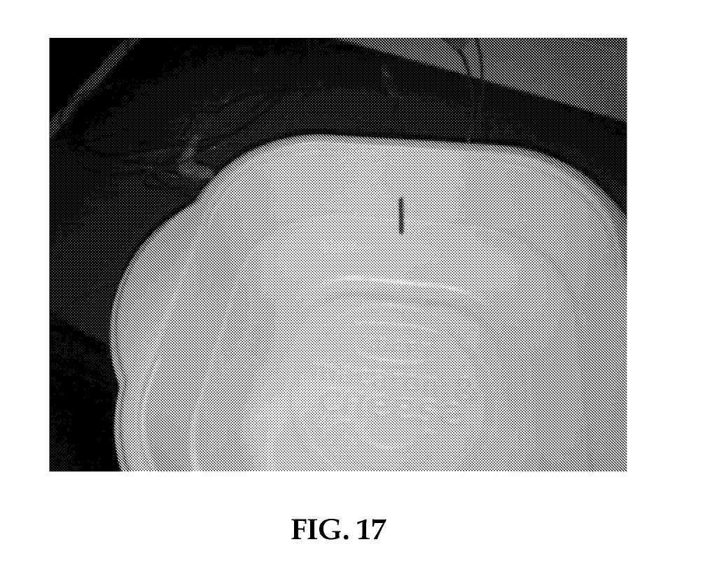

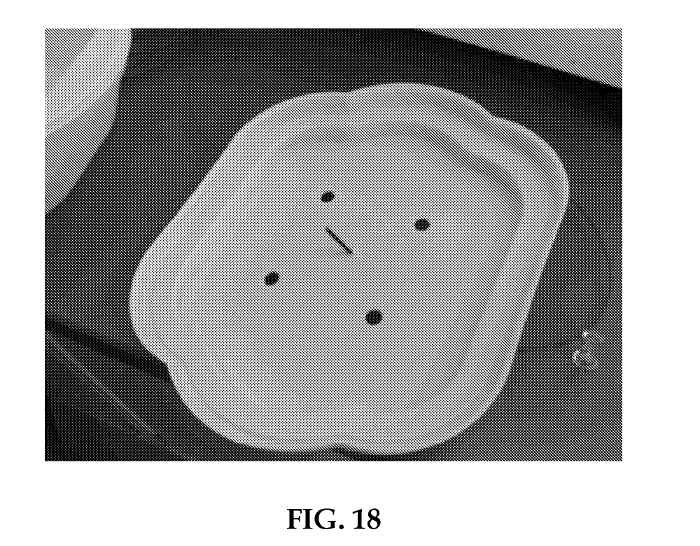

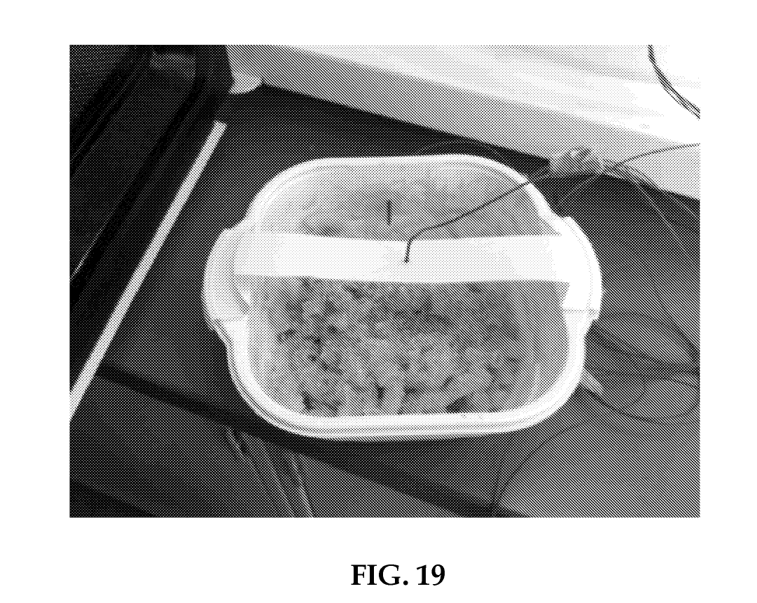

As part of this analysis, tests 1-4 were prepared using a container as shown in FIG. 1 and a lid as shown in FIG. 2A during a second heating step with a topping component while test 5 was prepared without a lid in the second heating step. Additionally, temperature probes were placed in the sidewall at the head space and lid to take temperature readings during the second heating step. Exemplary pictures showing the relative positions of the probes are shown in FIGS. 17, 18, and 19. The temperature profiles for Samples 2, 3, and 5 are shown in FIGS. 14-16.

TABLE 1

| | | | | Water loss | | | Total wt | Total wt | Water loss |
|---|---|---|---|---|---|---|---|---|---|
| | Pasta | Seasoning | Water | from heat | Cheese | Topping | pre-browning | post-browning | from browning |
| Test | Wt | Wt | Wt | step 1 | wt | Wt | cook step | cook step | cook |
| 1 | 60 | 6.1 | 166 | 73.1 | 40 | 5 | 224.45 | 210.05 | 14.4 |
| 2 | 59.82 | 6.27 | 171.17 | 67.24 | 40.26 | 5.28 | 236.74 | 228.3 | 8.44 |
| 3 | 59.56 | 6.4 | 169.86 | 64.32 | 39.87 | 6.09 | 237.96 | 233.05 | 4.91 |
| 4 | 60.32 | 6.19 | 172.1 | 73.47 | 38.34 | 5.19 | 229.03 | 226.8 | 2.23 |
| 5 | 60.85 | 6.29 | 169.89 | 75.09 | 39.72 | 4.94 | 228.08 | 220.46 | 7.62 |

TABLE 2

| | | | Max temp reached vs. time | Sufficient |
|---|---|---|---|---|
| Test | % water converted to steam | Cook time | on microwave display | browning? |
| 1 | 52.7% | 30 s | does not go over 200 | No |
| 2 | 44.2% | 45 s | 210 F. at 3 s remaining | Yes |
| 3 | 40.8% | 30 s | does not go over 200 | No |
| 4 | 44.0% | 45 s | 210 at 2 s remaining | Yes |
| 5 | 48.7% | 45 s | does not go over 200 | No |

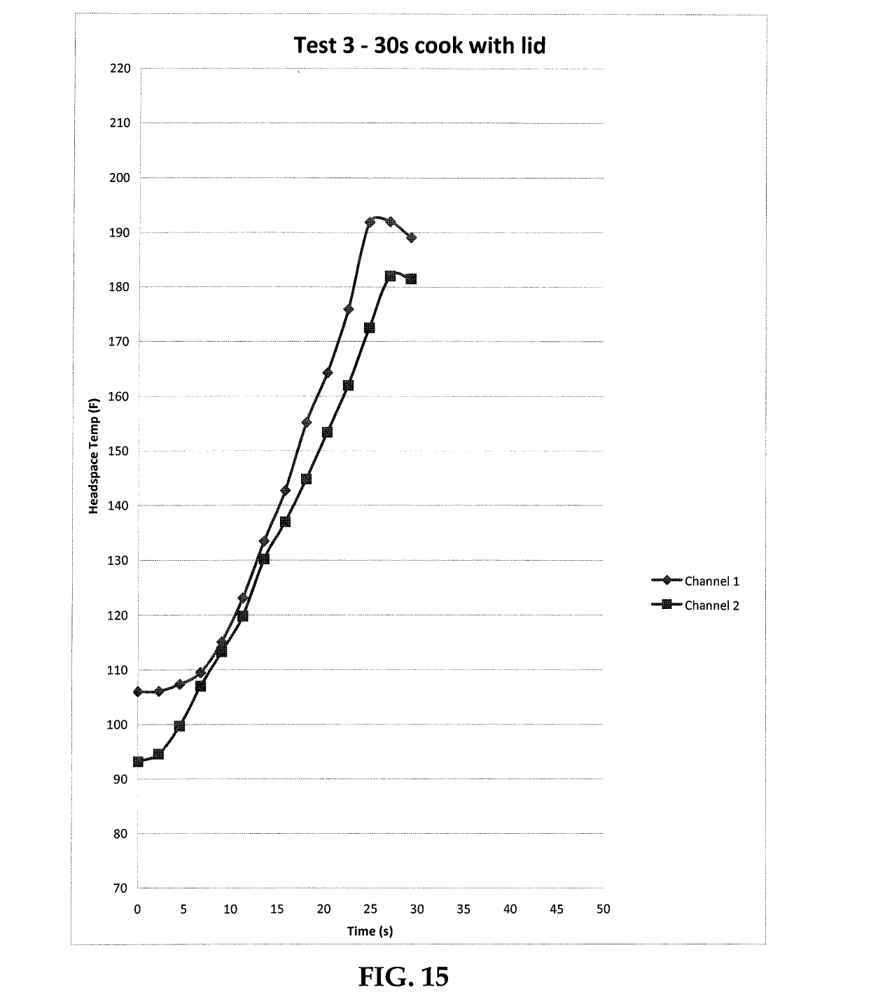

As seen in Tables 1 and 2, Samples 1 and 3 did not provide sufficient browning and did not exceed 200° F. in the head space. The head space may not have been provided sufficient heat and/or steam as the second heating step for each of Samples 1 and 3 was for only 30 seconds. The temperature profile of Sample 3 is shown in FIG. 15. It should be noted that the heating was not long enough to achieve a high enough temperature. When compared to Sample 2, such as shown in FIG. 14, and Sample 4, which were heated for 45 seconds, the head space achieved a temperature exceeding 210° F. prior to completion of the second heating step.

Therefore, in some approaches, an effective heating time in the second step may be selected in an effective ratio based on the amount of water lost from the first heating step so as to provide a temperature exceeding 210° F. prior to completion of the second heating step. Sample 5, on the other hand, did not include a lid and therefore never achieved a temperature over 200° F. even though it was heated for 45 seconds during the second heating step. However, the steam quality and other factors may affect the time and temperature conditions for desired browning. For example, the steam quality may affect the time necessary to achieve the desired browning characteristics such that higher quality steam may not require as long of time periods for the further heating step or as high of temperatures. Therefore, a lid, venting system and container geometry may be effective in combination to achieve the desired temperature and steam content effective to achieve the desired browning.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for preparing a microwavable food comprising the steps of:
adding a dehydrated food base and water to a container, the container having a side wall and a central location spaced from the side wall where a radial distance from the container side wall to the central location is not equidistant about a periphery of the container, a cooking chamber of the container containing the dehydrated food base and water, and a steaming chamber in the headspace of the container such that about 40 to about 45 percent of the container volume is the cooking chamber and about 55 to about 60 percent of the container volume is the steaming chamber;
heating the dehydrated food base and water in the cooking chamber of the container in a microwave for a first heating period to form at least a hydrated food base with an amount of residual water separate from the hydrated food base remaining in the cooking chamber after the first heating period;
mixing a sauce component with the hydrated food base and the residual water in the container;
adding a topping component to a top surface of the rehydrated food base to form a topped food material, the topping component including a browning material that is heat activated to effect a color change in the topping component;
covering the topped food material with a lid having a venting system; and
heating the topped food material in the microwave for a further heating period so that the residual water amount, the lid, and the venting system are effective to generate a sufficient amount of steam to be retained in the steaming chamber to achieve a temperature in the headspace of about 200 to about 210° F. for heat activating the browning material to effect the color change in the topping component.

2. The method of claim 1, wherein the further heating period is at least about 30 seconds to about 1 minute.

3. The method of claim 1, wherein the venting system includes through openings on the lid wherein the through openings provide a venting area of about 0.5 to about 20 percent of the total surface area of the lid.

4. The method of claim 1, wherein the residual water is about 8.5 to about 17 grams.

5. The method of claim 1, wherein the topping component is about 70 to about 95 percent starch and about 5 to about 30 percent browning agent capable of undergoing a maillard reaction upon exposure to the steam and temperatures achieved in the steaming chamber.

6. The method of claim 1, wherein an anti-foam composition is added to the dehydrated food base and water for the first heating step, the anti-foam composition including about 10 to about 30 percent surfactant, about 50 to about 70 percent instant starch, and at least about 15 percent salt component selected from sodium chloride or a sodium replacer.

7. The method of claim 1, wherein the dehydrated food base is selected from the group consisting of pasta, rice, potato slices, bread crumbs, and mixtures thereof.

8. The method of claim 1, wherein a ratio of the first heating period to the further heating period effective to hydrate and result in the color change of the topping component is about 5:1 to about 6.75:1.

9. The method of claim 1, wherein the steam is generated from the residual water and water provided by the sauce component.

10. The method of claim 1, wherein the hydrated food base, sauce component, residual water, and topping component are not mixed or stirred prior to the further heating step so that the topping component remains on an upper surface of the hydrated food base.

11. The method of claim 1, wherein the residual water amount, the lid, and the venting system are effective to generate about 0.03 to about 0.5 grams of steam per second.

12. A microwavable food product system and container comprising:
a container having a side wall and defining a central location where a radial distance from the container side wall to the central location is not equidistant about a periphery of the container, the container defining a cooking chamber containing the dehydrated food base and a steaming chamber in a headspace above the cooking chamber such that a ratio of the cooking chamber to the steaming chamber is about 1 to about 1.4;
a dehydrated food product base configured to be rehydrated with water by a user during a first heating period in a microwave, the dehydrated food product base contained in the cooking chamber;
a sauce component;
a topping component including a browning material, the topping component configured to be applied to a top surface of the food product base after being rehydrated, the browning material being heat activatable to provide browning characteristics to the top surface of the food product base; and
a lid configured to cooperate with the container, at least one of the container and lid including a venting system having through openings therein of about 0.5 to about 20 percent of the surface area of the container or lid and configured to permit an effective amount of steam to be retained in the steaming chamber to achieve a temperature of about 200° F. to about 210° F. in the headspace above the cooking chamber during microwave heating.

13. The microwaveable food product system and container of claim 12, wherein the container side wall defines at least one corner.

14. The microwaveable food product system and container of claim 12, wherein the residual water amount, the lid, and the venting system are effective to generate about 0.03 to about 0.5 grams of steam per second.

15. The microwaveable food product system and container of claim 12, wherein the topping component is about 70 to about 95 percent starch and about 5 to about 30 percent browning agent capable of undergoing a maillard reaction upon exposure to the steam and temperatures achieved in the steaming chamber. The microwaveable food product system and container of claim 12, further comprising an anti-foam composition including about 10 to about 30 percent surfactant, about 50 to about 70 percent instant starch, and at least about 15 percent salt component selected from sodium chloride or a sodium replacer.
